(19) United States
(12) Patent Application Publication
(10) Pub. No.: US 2010/0241318 A1
(43) Pub. Date: Sep. 23, 2010

(54) method and control device for triggering passenger protection means for a vehicle

(76) Inventors: Alfred Kuttenberger, Herrenberg (DE); Bastian Reckziegel, Kirchheim/Nabern (DE)

Correspondence Address: KENYON & KENYON LLP, ONE BROADWAY, NEW YORK, NY, 10004, US

(21) Appl. No.: 12/744,657

(22) PCT Filed: Oct. 23, 2008
(86) PCT No.: PCT/EP2008/064379

§ 371 Date: May 25, 2010

(30) Foreign Application Priority Data
Dec. 12, 2007 (DE) 10 2007 059 898.1

(51) Int. Cl. B60R 21/01

(52) U.S. Cl. 701/46

(57) ABSTRACT

A control device and a method for triggering passenger protection arrangement for a vehicle are described, in which the triggering occurs as a function of at least one signal from a rear crash sensor system monitoring a rear region of the vehicle. The triggering of the passive passenger protection arrangement takes place as a function of at least one threshold comparison of the at least one signal.

### FIELD OF THE INVENTION

The present invention relates to a method and a control device for triggering a passenger protection arrangement for a vehicle.

### BACKGROUND INFORMATION

A safety system for a motor vehicle is discussed in DE 198 58 292 C2, in which the brake force of the brake as a passenger protection arrangement is taken into account as a function of a relative velocity and a distance to a vehicle driving ahead and behind.

### SUMMARY OF THE INVENTION

In contrast, the method and the control device for triggering a passenger protection arrangement according to the exemplary embodiments and/or exemplary methods of the present invention for a vehicle having the features of the independent claims have the advantage that the triggering of the passive passenger protection arrangement such as airbags, belt tighteners and crash-active headrests is now implemented as a function of a threshold comparison of the at least one signal from the surround sensor system that monitors the rear region. As a result, the passive protection arrangement are triggered now as well in order to offer optimum protection to a vehicle occupant. The at least one threshold comparison ensures a precise assessment of the signal from the surround sensor system. With its aid it is possible, in particular, to identify ranges in which no influencing control of the triggering of the passive protection arrangement by the threshold comparison is to take place.

In the present case, a passive passenger protection arrangement such as airbags, belt tighteners and crash-active headrests etc. are triggered. Triggering in this case means the activation of such a passive passenger protection arrangement. The signal from the surround sensor system may be an individual signal, an already pre-processed signal, or a raw signal or also a multitude of individual signals. Pre-processing denotes all kinds of measures, such as filtering, averaging, integrating, subtracting, and so on.

The surround sensor system is a radar, ultrasonic, video and/or lidar and/or capacitive sensor system, with whose aid the environment of the rear region of the vehicle is able to be monitored. The placement of the sensor system in the vehicle depends upon its technology.

The at least one threshold comparison means that the signal is compared to a predefined threshold, it also being possible for the threshold to be an adaptive threshold, i.e., a threshold which is able to be influenced as a function of the signal itself and/or additional variables.

In the case at hand, a control device refers to an electric device which processes sensor signals such as from the surround sensor system, for example, and outputs trigger signals for the passenger protection arrangement as a function thereof.

An interface is a hardware and/or software realization, which supplies the at least one signal in the control device. When realized in hardware, it is possible for the interface to be implemented as an integrated switching circuit, a plurality of integrated switching circuits, a combination of integrated and discrete components or to be made up only of discrete components. When realized in software, the interface is a software module, for example, situated on a microcontroller of the control device.

The evaluation circuit may likewise be implemented in hardware and/or software. When implemented in software, the evaluation circuit is a software module, e.g., on the microcontroller of the control device, the evaluation circuit utilizing the interfaces of the microcontroller for receiving and emitting signals. In particular, the evaluation circuit has a threshold comparison element in the form of a hardware and/or software module. In addition, an output circuit, which transmits an implementation signal to the trigger circuit as a function of an output signal of the threshold comparison element, is disposed in the evaluation circuit. The output circuit may be implemented in hardware and/or software as well.

The trigger circuit, too, may be implemented in hardware and/or software. In particular, it is possible for the trigger circuit to be part of the system ASIC, which includes a plurality of functions for the control device.

Advantageous improvements of the method and control device for triggering passenger protection arrangement for a vehicle recited in the independent claims are rendered possible by the measures and further refinements recited in the dependent claims.

It is advantageous that at least one trigger threshold is influenced as a function of the at least one signal. This means that the threshold comparison to which the at least one signal is subjected is utilized to influence the trigger threshold, i.e., the threshold that a crash signal must exceed in order to cause the triggering. This may be done by a lowering, i.e., a more sensitive setting.

Furthermore, it is advantageous that the condition is checked according to which the triggering is suppressed when the at least one signal or a derivation thereof lies under a minimum threshold. This makes it possible, for example, to check whether the relative velocity lies below a specific threshold, in which case the triggering will then be suppressed. In other words, if the relative velocity is too low, then there will be a minor collision only, so that, for instance, there is no need to set the trigger groove to a more sensitive setting.

The threshold value comparison of the at least one signal may advantageously be used for plausibilizing a trigger decision. This safeguards this trigger decision in a rear collision, in particular.

Furthermore, it is advantageous that the threshold of the threshold comparison is modified as a function of a comparison. This makes it possible to implement an adaptive threshold.

In addition, it is advantageous that the influencing of the at least one trigger threshold and/or the modification of the at least one trigger threshold is implemented for a specified period of time as a function of the at least one signal, and then is cancelled again. This takes into account that the more sensitive setting is implemented for only a certain period of time, e.g., in order to avoid unnecessary trigger situations of the passive passenger protection arrangement.

In an advantageous manner, an object type may be used as the at least one signal. For example, the object type is a passenger car or a commercial truck or a motorcycle and may thus cause a particular threshold adaptation of the trigger threshold.

Furthermore, it is advantageous that the at least one signal is compared to a minimum threshold after a specific period of time. Triggering of the personal protection arrangement that takes place too late is able to be prevented in this manner.

Furthermore, it is advantageous that the trigger dependency is suppressed by a driving direction. In this way crash scenarios in which no triggering of the personal protection arrangement is to take place are able to be identified. For instance, when driving in reverse, which is able to be detected by the intrinsic speed or by evaluating the driving gear controller (reverse gear), the triggering of the passive passenger protection arrangement is able to be prevented.

Exemplary embodiments of the present invention are illustrated in the drawing and explained in greater detail in the following description.

### BRIEF DESCRIPTION OF THE DRAWINGS

FIG. 1 shows a block diagram of the control device according to the present invention with connected components in a vehicle.

FIG. 2 shows a block diagram of a microcontroller in a control device according to the present invention.

FIG. 3 shows a first flow chart of the exemplary method.

FIG. 4 shows a second flow chart of the exemplary method.

FIG. 5 shows a third flow chart of the exemplary method.

### DETAILED DESCRIPTION

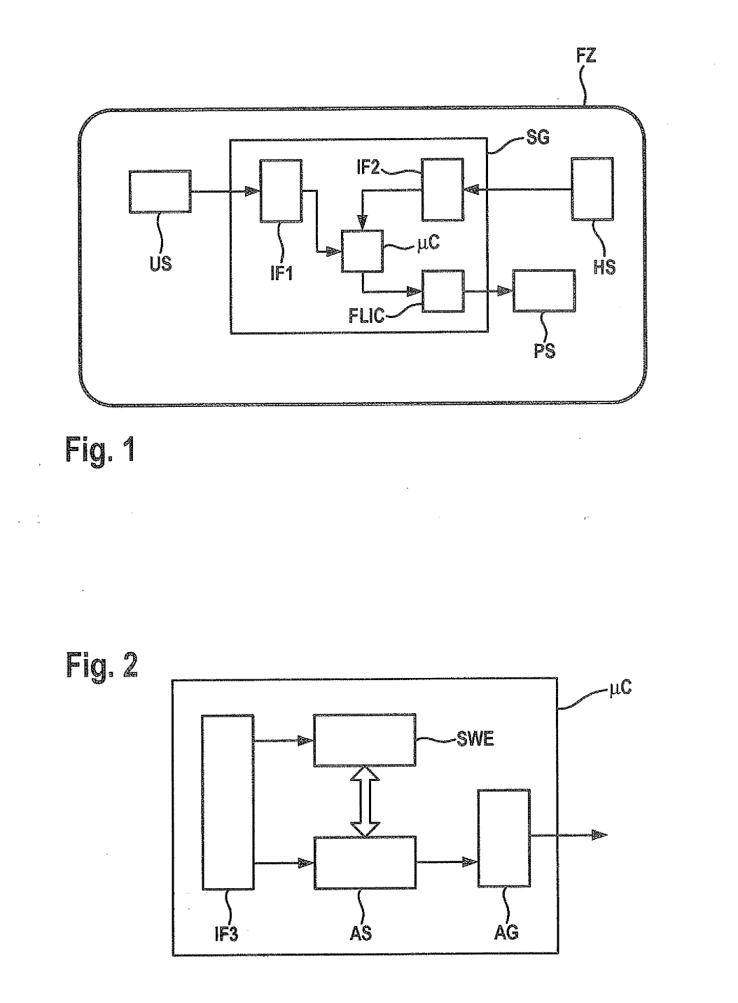

FIG. 1 shows control device SG according to the present invention in a vehicle FZ with connected components of a crash sensor system US, a rear sensor system HS, and the passive passenger protection arrangement PS.

Crash sensor system US in this case has been illustrated as being situated outside control device SG. It is possible that parts of crash sensor system US are located inside control device SG. Crash sensor system US may include acceleration sensors, structure-borne noise sensors, air pressure sensors, force sensors and/or all other known sensors for detecting a crash. The signals from crash sensor system US are usually transmitted digitally, for instance via a current interface, to interface IF1 in control device SG, interface IF1 being implemented as hardware in the present case, for example as part of a so-called system ASIC, which includes many functions of control device SG.

Rear sensor system HS, which is designed as crash sensor system in the present case and which monitors the rear region of vehicle FZ, is connected to interface IF2, which likewise is situated inside control device SG. Interface IF2 is developed in hardware here as well and may also be part of the system ASIC. Rear sensor system HS is a surround sensor system such as ultrasound, video or radar or lidar, or a capacitive surround sensor system, which is situated in such a way that it monitors the rear region of vehicle FZ. These data, too, are digitally transmitted to control device SG.

A microcontroller μC in control device SG processes the sensor signals from crash sensor system US or rear sensor system HS. Microcontroller μC generates a trigger signal as a function thereof, which is forwarded to a trigger circuit FLIC in order to induce triggering of the passenger protection arrangement PS. Trigger circuit FLIC may also be part of the system ASIC.

According to the exemplary embodiments and/or exemplary methods of the present invention, the trigger decision is influenced as a function of a threshold comparison of the signals from rear sensor system HS. This may be done, for example, in that, based on the threshold comparison of the signal from rear sensor system HS, a decision is made as to whether to modify, i.e., in particular lower, a trigger threshold that must be exceeded by the signal from crash sensor system US. In the present case, if signals are mentioned, this also includes instances where this refers to the processed signals. In other words, it is not necessarily a raw signal from the crash sensor system or the rear sensor system that is used, but, for example, a filtered, averaged or integrated signal. Other processing methods are conceivable here as well.

FIG. 2 shows microcontroller μC having software modules, which may, however, also be implemented as hardware modules, individually, in groups or overall. Interface IF3 provides the signals of crash sensor system US and rear sensor system HS in microcontroller μC for the algorithm and threshold value control SWE. Algorithm AS determines whether or not the passive passenger protection arrangement are to be triggered. Based on the signal from rear sensor system HS, a determination is made in module SWE whether or not the trigger decision in algorithm AS is to be influenced as a function of this signal. The corresponding influencing is determined as a function of at least one threshold comparison of this signal. If algorithm AS has ultimately made a trigger decision, it forwards it to output circuit AG. This output circuit uses the hardware of microcontroller μC to transmit a signal to trigger circuit FLIC in order to induce this trigger circuit to activate passenger protection arrangement PS, e.g., by energizing ignition elements. In this context the triggering of a belt tightener able to be triggered electromotorically is possible as well.

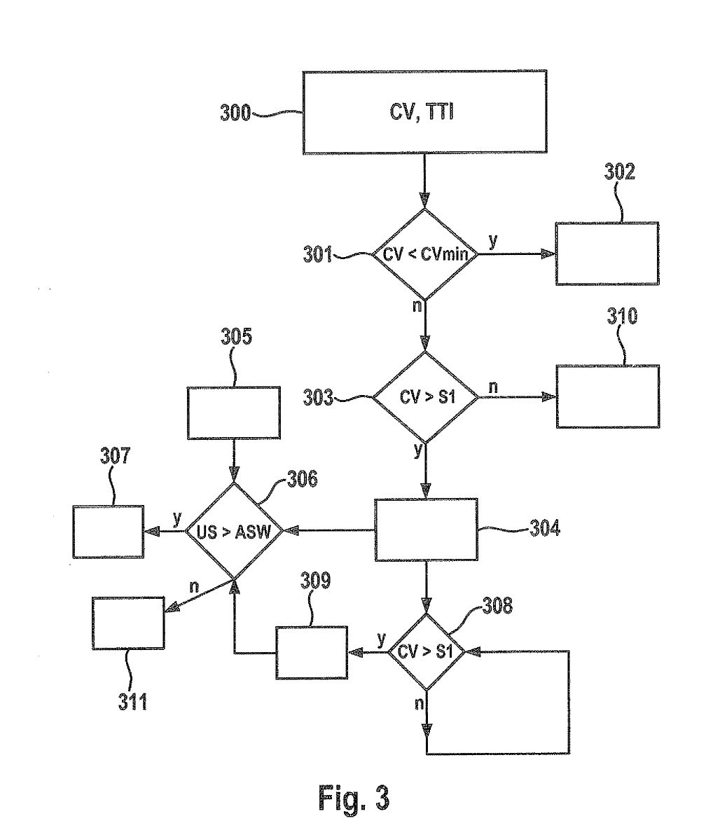

FIG. 3 shows the method according to the present invention in a flow chart. In method step 300, the relative speed between the impact object and vehicle CV as well as the time until impact—also denoted as time to impact TT1—is determined from the signal of rear sensor system HS as parameter.

In method step 301, it is then checked whether relative speed CV is less than a minimum threshold CVmin. If this is the case, then the triggering of the passenger protection arrangement is suppressed in method step 302. If this is not the case, then it is checked in method step 301 whether the relative speed is greater than a first threshold S1. If this is not the case, then the forming of the trigger decision will not be influenced in method step 310 because one is then within the range of the relative speed between minimum threshold CVmin and first threshold S1. However, if first threshold S1 was exceeded by relative speed CV, then the trigger threshold is influenced in method step 304. In a first path, trigger threshold ASW is influenced in method step 306. For in method step 306, crash signal 305 US is compared to trigger threshold ASW. This trigger threshold is influenced by method step 304, for example by lowering it, that is to say, by a higher sensitivity setting. If the trigger threshold was exceeded by crash signal US, then the triggering takes place in method step 307. However, this happens only if, based on method step 304, a plausibility check was implemented in method steps 308 and 309 using the signal from the rear sensor system. This independent decision is frequently a necessary criterion in trigger decisions. This plausibility check is performed by comparing the relative speed with a second threshold S2 in method step 308. If this threshold is exceeded, then the plausibility is established in method step 309 and taken into account in method step 306. If the plausibility has not been established, then the checking continues.

The time up to impact TTI may be used to determine a range within which a threshold control is permitted. For example, after initiating a counter, it may be reduced in each computing cycle. It the counter does not attain a threshold value S1, then a comparison as to whether the counter is below this threshold value S1 and above a further threshold value S2 takes place in the case of a crash. In the event that both conditions are met, the thresholds for triggering the restraining arrangement are influenced as a function of the relative speed and/or additional parameters.

If it was determined in method step 306 that crash signal US does not lie above trigger threshold ASW, then the method ends in method step 311.

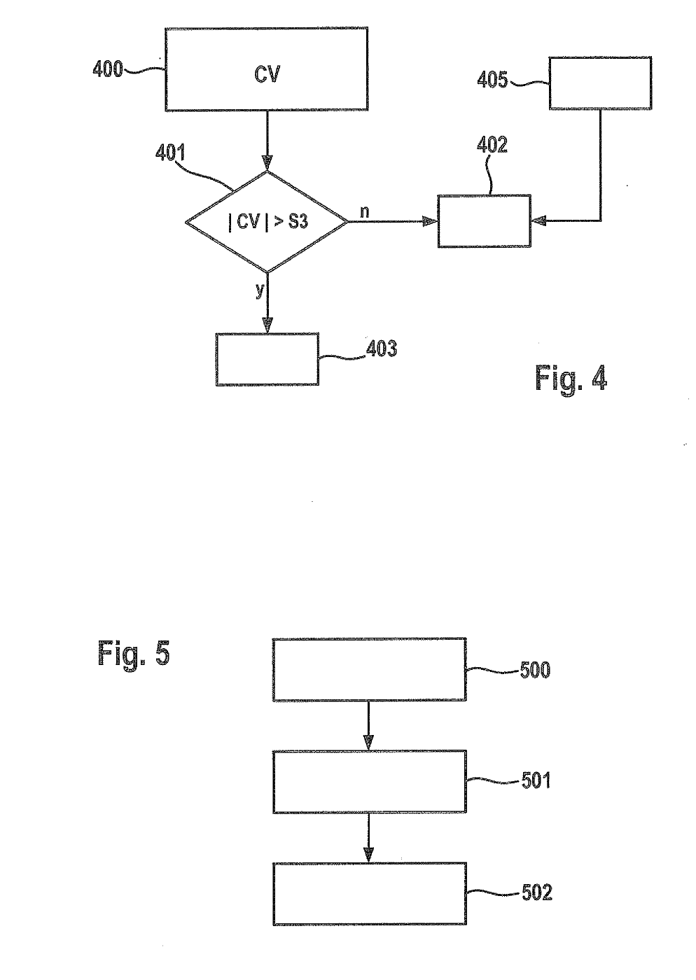

FIG. 4 shows an additional flow chart of the method according to the present invention. In method step 400, the relative speed is provided by the signal from rear sensor system HS. In method step 401, the amount of the rear speed is compared with a third threshold S3. If the amount lies above threshold S3, then the triggering takes place in method step 403. However, if the amount is not above threshold S3, then the triggering is suppressed in method step 402 due to a lack of plausibility. This is also done when the vehicle is moving in reverse, which is determined in method step 405.

FIG. 5 shows once more that driving in reverse leads to a suppression of the triggering. In method step 500, the signal from the rear sensor system is provided. In method step 501, it is determined whether driving in reverse is taking place based on the intrinsic speed or the evaluation of the gear controller. In such a case no triggering takes place in method step 502.

The influencing of the trigger threshold may be specified to be implemented continuously or in different stages or by a mathematical rule.

1-10. (canceled)

11. A method for triggering a passenger protection arrangement for a vehicle, the method comprising:
providing at least one signal from a surround sensor system monitoring a rear region of the vehicle;
performing at least one threshold comparison of the at least one signal; and triggering the passenger protection arrangement as a function of the at least one signal from the surround sensor system monitoring the rear region of the vehicle, wherein the triggering of passive passenger protection means occurs as a function of the at least one threshold comparison of the at least one signal.

12. The method of claim 11, wherein at least one trigger threshold is influenced as a function of the at least one signal.

13. The method of claim 11, wherein the triggering is suppressed when one of the at least one signal and a derivation of the at least one signal lies below a minimum threshold.

14. The method of claim 11, wherein the threshold comparison is used for a plausibility check.

15. The method of claim 14, wherein at least one threshold of the threshold comparison is modified as a function of the comparison.

16. The method of claim 13, wherein at least one of an influencing of the at least one trigger threshold and a modification of the at least one threshold is implemented as a function of the at least one signal for a specified period of time and then canceled again.

17. The method of claim 11, wherein an object type is used as the at least one signal.

18. The method of claim 13, wherein the at least one signal is compared to the minimum threshold after a specified period of time.

19. The method of claim 11, wherein the triggering is suppressed as a function of the driving direction.

20. A control device for triggering a passenger protection arrangement for a vehicle, comprising:
an interface arrangement to provide at least one signal of a surround sensor system monitoring a rear region of the vehicle; and
an evaluation arrangement to induce a trigger arrangement to trigger the passenger protection arrangement as a function of the at least one signal;
wherein the evaluation arrangement includes a threshold comparator for the at least one signal, and further includes an output arrangement to transmit an implementation signal to the trigger arrangement as a function of an output signal of the threshold comparator, so that the trigger arrangement triggers the passive passenger protection arrangement.
